(19) United States
(12) Patent Application Publication
(10) Pub. No.: US 2022/0147553 A1
(43) Pub. Date: May 12, 2022

(54) COMPUTERIZED ASSESSMENT OF ARTICLES WITH SIMILAR CONTENT AND HIGHLIGHTING OF DISTINCTIONS THEREBETWEEN

(71) Applicant: International Business Machines Corporation, Armonk, NY (US)

(72) Inventors: Ankit Kumar Singh, Ranchi (IN); Ratul Sarkar, Bangalore (IN); Srinivasan S. Muthuswamy, Ibblur (IN); Subhendu Das, Chapel Hill, NC (US); Nikhil Sai Krishna Jonnavithula, Visakhapatnam (IN)

(21) Appl. No.: 17/092,140

(22) Filed: Nov. 6, 2020

(51) Int. Cl. G06F 16/35; G06F 16/31; G06F 16/383; G06F 40/289

(52) U.S. Cl. CPC G06F 16/358; G06F 40/289; G06F 16/383; G06F 16/328

(57) ABSTRACT

A computer receives a list of reference topics from a topic database and a set of articles related to said reference topics. The computer generates article n-grams and compares them to the reference topics using NLP to determine a primary theme for each article that corresponds to one of reference topics. The computer collects articles with common primary themes into at least one article group and determining an article comparison value between articles in the article group. Responsive to determining that an article comparison value is below a predetermined similarity threshold, determining a distinguishing feature associated with one of the compared articles that contributed to the article comparison value. The computer assigns articles having the distinguishing feature into a secondary group based, at least in part, on the distinguishing feature.

### BACKGROUND

The present invention relates generally to the field of computer-implemented content collection, and more particularly, to automated methods of gathering information (e.g., such as news articles) about selected parties.

Computer-implemented data gathering can streamline due diligence activities by ensuring risk assessment is conducted with relevant knowledge about a given entity. For example, news articles or information may be gathered and presented to an analyst who will, for example, make a risk assessment about a given party. In some cases, the party is a prospective business partner and news about behavior of the prospective partner can be helpful in making an informed decision. Unfortunately, many publicly-available sources of information are unstructured and gathering information often provides duplicative results. For some particularly popular parties and topics, the sheer volume of information available can make it burdensome to make an accurate assessment.

### SUMMARY

According to one embodiment, a computer-implemented method to selectively group topical content includes receiving a list of reference topics from a topic database and a set of articles related to said reference topics. The computer generates for each article, an article n-gram that represents the content of the associated article. The computer compares, using Natural Language Processing (NLP), the article n-grams with the reference topics to determine which reference topics is most similar to each article n-grams. In response to the comparison, the computer assigns a primary theme to the articles associated with the compared article n-grams. The assigned primary themes correspond to the most-similar reference topic. The computer collects articles with common primary themes into at least one article group and determines an article comparison value between articles in the article group. Responsive to determining that an article comparison value is below a predetermined similarity threshold, the computer determines a distinguishing feature associated with one of the compared articles that contributed to the article comparison value. The computer assigns articles having the distinguishing feature into a secondary group based, at least in part, on the distinguishing feature.

According to aspects of the invention, the reference topics are selected from a list consisting of activities and related phases thereof.

According to aspects of the invention, the primary themes are determined, at least in part, by the computer receiving sets of topic n-grams representing the reference topics; by the computer generating sets of article n-grams representing content of said articles; and by the computer comparing article n-grams with topic n-grams.

According to aspects of the invention, the article comparison value is determined, at least in part, by the computer generating article feature vectors representing content of articles and by the computer comparing article feature vectors of pairs of articles in the group.

According to aspects of the invention, the computer compares feature vectors by a cosine similarity algorithm.

According to aspects of the invention, the computer selects the distinguishing feature from a list including a relevant date, and presence of a secondary theme.

According to aspects of the invention, the distinguishing feature includes an article date for a first compared article that is separated time-wise from an article date for a second compared article by a time gap larger than a predetermined same-topic threshold.

According to another embodiment, a system to selectively group topical content, comprises: a computer system comprising a computer readable storage medium having program instructions embodied therewith, the program instructions executable by a computer to cause the computer to: receive a list of reference topics from a topic database; receive a set of articles related to said reference topics; generate, for each article, an article n-gram that represents the content of the associated article; compare, using Natural Language Processing (NLP), said article n-grams with said reference topics to determine which of said reference topics is most similar to each of said article n-grams; responsive to said comparing, assign a primary theme to the articles associated with each of said compared article n-grams, said assigned primary themes each corresponding respectively to the most-similar reference topic; collect articles with common primary themes into at least one article group and determine an article comparison value between articles in the at least one article group; responsive to determining an article comparison value that is below a predetermined similarity threshold, determine at least one distinguishing feature associated with at least one of the compared articles that contributed to the article comparison value; and assign articles having said distinguishing feature into a secondary group based, at least in part, on said at least one distinguishing feature.

According to another embodiment, a computer program product to selectively group topical content, the computer program product comprising a computer readable storage medium having program instructions embodied therewith, the program instructions executable by a computer to cause the computer to: receive, using said computer, a list of reference topics from a topic database; receive, using said computer, a set of articles related to said reference topics; generate, for each article, using said computer, an article n-gram that represents the content of the associated article; compare, using said computer, using Natural Language Processing (NLP), said article n-grams with said reference topics to determine which of said reference topics is most similar to each of said article n-grams; responsive to said comparing, assign, using said computer, a primary theme to the articles associated with each of said compared article n-grams, said assigned primary themes each corresponding respectively to the most-similar reference topic; collect, using said computer, articles with common primary themes into at least one article group and determine an article comparison value between articles in the at least one article group; responsive to determining an article comparison value that is below a predetermined similarity threshold, determine, using said computer, at least one distinguishing feature associated with at least one of the compared articles that contributed to the article comparison value; and assign, using said computer, articles having said distinguishing feature into a secondary group based, at least in part, on said at least one-distinguishing feature.

The present disclosure recognizes the shortcomings and problems associated with collecting and assessing large amounts of semantically-similar data. The present invention provides aspects that collect articles, while showing selected distinctions among them (e.g., articles showing distinct, new, or repeated instances of a given behavior over time, articles that provide cumulative or follow-up discussion of a given topic, and information that references a selected topic as well as additional topics beyond the scope of inquiry). Aspects of the invention provide benefits associated with highlighting distinctions among multiple articles and presenting topically-similar information in a manner that supports various assessment activities.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a computer-implemented system that groups articles having related content and distinguishes between similar article discussing distinct topics.

FIG. 2 is a flowchart illustrating a method, implemented using the system shown in FIG. 1, of grouping articles having related content and distinguishing between similar articles discussing distinct topics according to aspects of the invention.

FIG. 3 is a schematic representation of articles discussing behavior associated with a common entity and related to selected reference topics according to aspects of the invention.

FIG. 4 is a schematic representation of articles shown in FIG. 3 grouped by topic according to aspects of the invention.

FIG. 5 is a schematic representation of articles shown in FIG. 4 grouped further using article distinguishing features according to aspects of the invention.

FIG. 6 is a table including aspects of reference topics provided according to aspects of the invention.

FIG. 7 is a table including aspects of articles provided according to aspects of the invention.

FIG. 8 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 9 depicts a cloud computing environment according to an embodiment of the present invention.

FIG. 10 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

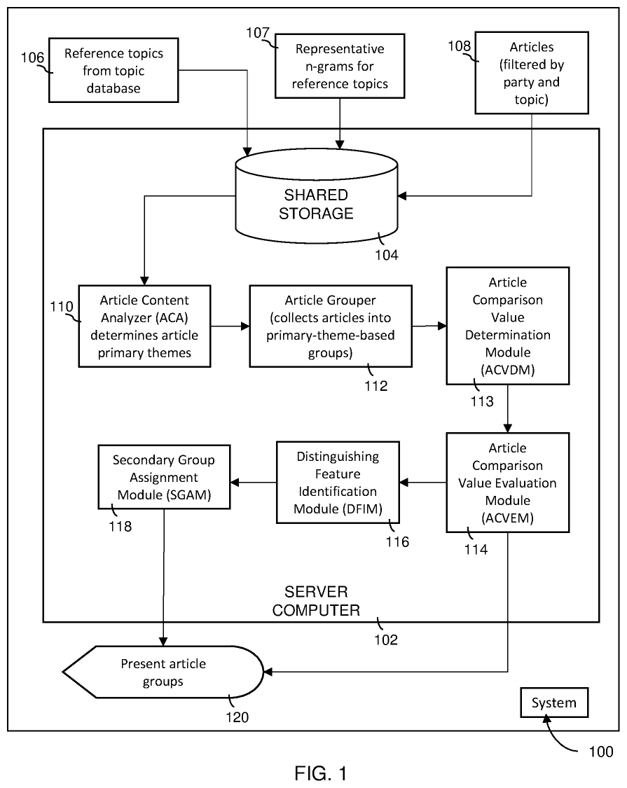

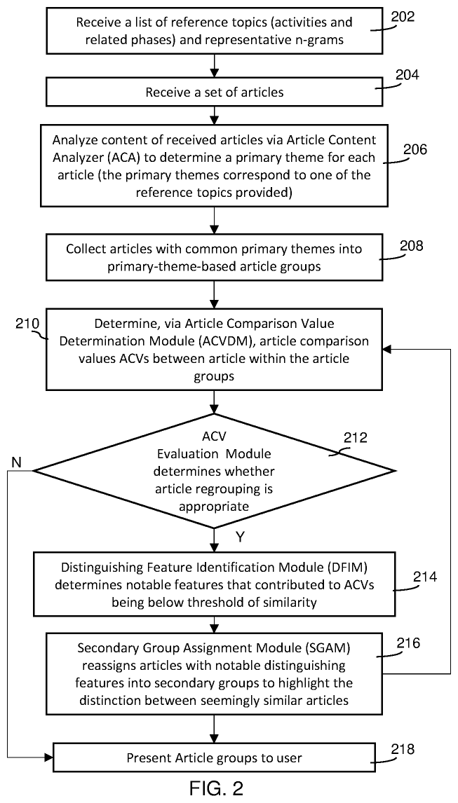

Now with combined reference to the Figures generally and with particular reference to FIG. 1 and FIG. 2, an overview of a computer-implemented method to group and show distinctions among articles having related content is shown. The method is conducted within system 100 and carried out by server computer 102 having optionally shared storage 102 and aspects that distinguish between similar articles discussing distinct topics, according to embodiments of the present disclosure.

With continued reference to FIG. 1, the server computer 102 is in communication with sources (e.g., such as a topic database) of reference topics 106, representative topic n-grams 107, and articles 108. According to aspects of the invention, the received articles 108 are pre-filtered using known search filtering techniques to relate to a selected party and to discuss activity associated with a preselected list of reference topics 106 provided. According to aspects of the invention, reference topics 106 provided may cover a wide range of activities including sporting accomplishments, professional accolades, speaking engagements, alleged criminal activity, and other activities of interest, as well as various phases of activity related to those activities selected in accordance with the judgment of one skilled in this field. Articles 108 may be provided in a variety of formats, including news articles (both print and multimedia), social media posts, online web and other internet content, and other information formats selected in accordance with the judgment of one skilled in this field. It is also noted that some articles may provide information about similar activities, the same occurrence of a particular activity, and various combinations thereof. The server computer 102 includes Article Content Analyzer (MCA) 110 that determines and assigns a primary theme for each provided article 108. The server computer 102 also includes article grouper 112 that collects articles 108 into primary-theme-based groups 402, 404, 406. The server computer 102 includes Article Comparison Value Determination Module (ACVDM) 113 that evaluates the similarity of articles that share a common assigned primary theme. ACVDM 113 passes Article Comparison Values (ACVs) to Article Comparison Value Evaluation Module (ACVEM) 114 that determines whether further article grouping is appropriate, according to aspects of the invention. The server computer 102 includes a Distinguishing Feature Identification Module (DFIM) 116 that, if such re-grouping is appropriate as described below, identifies attributes of articles 108 that although sharing a common primary theme, are distinct from one another. The server computer 102 incudes a Secondary Group Assignment Module (SGAM) 118 that, as will be more fully described below, re-assigns semantically-similar, yet distinct, articles 108 into secondary groups 504, 508, 512 according, at least in part, to distinguishing features identified by the DFIM 116. Once selected article 108 have been grouped, the groups of articles are presented in a display 120, stored, or otherwise shared with a user for consideration during a due diligence investigation or for another purpose selected by one skilled in this field.

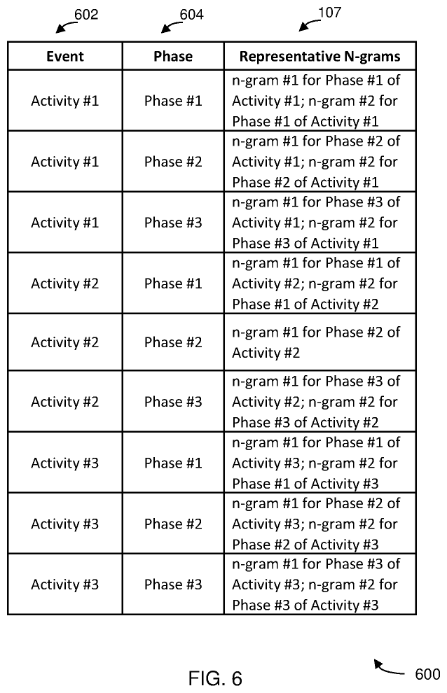

Now with particular reference to FIG. 2, the method of the present invention will be discussed. The server computer 102 receives, at block 202, a list of topics 106 and representative n-grams 107 for those topics. As shown, for example, in FIG. 6, the provided topics 106 could include the occurrence of predetermined activities, including multi-stage events 602 and various phases 604 related to those events. The provided topic n-grams 107 promote consistent primary theme 706 assignment by MCA 110, which (as described below) uses natural language processing (NLP) to associate reference topics 106 with the provided articles 108. According to aspects of the invention, in support of due diligence activities, reference topics 106 relate to information that could impact a decision to work with a given party (e.g., negative news, including alleged crimes), while related activities 604 include associated phases or procedural stages. It is noted that as used herein, the term “party” may refer to an individual, group, or other entity about whom an investigation is being conducted. It is also noted that as used herein, the term “article” may refer news articles, social media postings, database entries, and other sources of topical information selected by one skilled in this field.

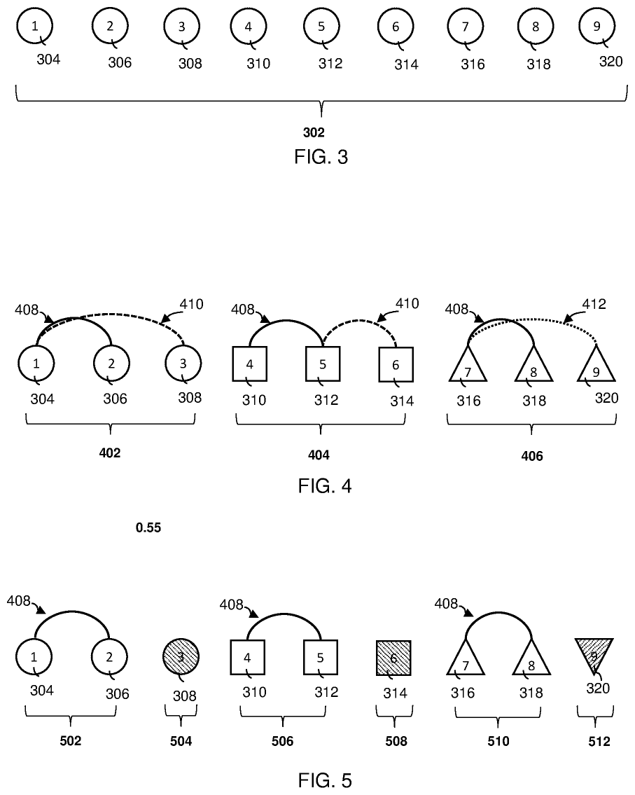

The server computer 102 receives, at block 204, articles 108 filtered to contain information about a party (not shown) and at least one of the predetermined reference topics 106. This is shown schematically in FIG. 3, where an exemplary set 302 of article nodes 304, 306, 308, 310, 312, 314, 316, 318, and 320 discussing a single event 602 is provided. As noted elsewhere, according to some aspects of the invention, reference topics 106 may relate to events 602 which a system user (e.g., an analyst) will consider useful.

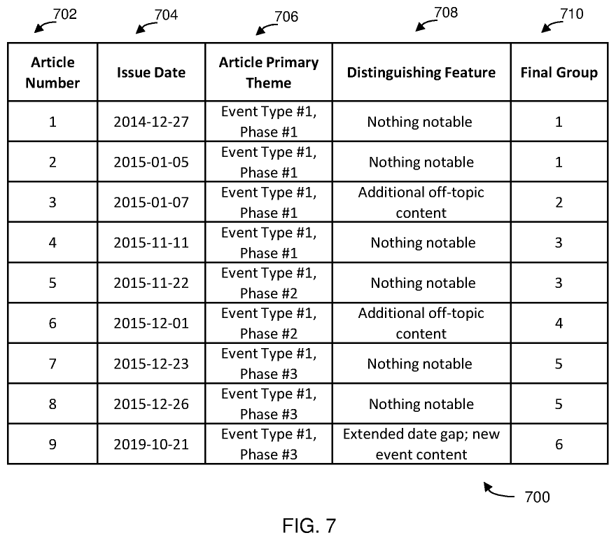

The server computer 102, via MCA 110 at block 206, determines a primary theme 706 (seen, e.g., in the article metadata table 700 of FIG. 7) for each article 108.

The article primary themes 706 are related to the reference topics 106 provided, and the articles represented in group 302 all have “Topic #1”-related article primary themes 706. The server computer 102, via the MCA 110 in block 206, determines and assigns article primary themes 706 through Natural Language Processing (NLP) techniques. In particular, according to aspects of the invention, MCA 110 generates a set of article n-grams 109, each member of which represents the content of a respective received article 106. According to aspects of the invention, MCA 110 assigns a topic to each article 106 by comparing the associated article n-gram 109 with each of the received topic n-grams 107 (e.g., via string similarity, cosine similarity of representative n-gram vectors, or some other known NLP comparison technique selected by one skilled in this field) to find a closet match. By comparing n-grams 107, 109, MCA 110 determines which of the received topics 106 is the closest match for (i.e., is the most similar to) each of the received articles 108 and assigns a respective primary theme 706 to the received articles accordingly. According to aspects of the invention, each of the primary themes 706 assigned by MCA 110 corresponds to one of the received topics 106. The n-grams 109 representing content received articles 108 are generated through known approaches, such as functions available in the Python programming language, functions in NLP libraries such as the Natural Language Toolkit (“NLTK”), or other appropriate method selected by one skilled in this field. It is noted that article primary themes 706 may be generated in other known manners selected in accordance with the judgment of one skilled in this field.

The server computer 102 also records static metadata (including, e.g., an article number 702, an issue date 704, and article primary theme 706) at block 206. For clarity, it is noted that the article nodes 304, 306, 308, 310, 312, 314, 316, 318, and 320 correspond respectively to article numbers 1-9 in table 700. As noted above, the articles represented in node set 302 all broadly discuss the “Topic #1” and each article in the set has (as shown, e.g., in FIG. 7) a Topic #1-related article primary theme 706.

With continued reference to FIG. 2 and with additional reference to FIG. 4 the server computer 102 collects, via article grouper 112 at block 208, articles 108 into primary-theme-based groups 402, 404, and 406. In the present embodiment, the primary-theme-based groups 402 (represented by circles in FIG. 4), 404 (represented by squares in FIG. 4), and 406 (represented by triangles in FIG. 4) correspond, respectively, to article primary themes 706 identified schematically as “Event Type #1, Phase 1”, “Event Type #1, Phase 2”, and “Event Type #1, Phase #3”.

The server computer 102 determines, via ACVDM 113 at block 210, an article comparison value (MCV) 408, 410, and 412 (e.g., as shown schematically in FIG. 4) between article pairs in a given article group 402, 404, 406. According to aspects of the invention, the article comparison value MCV is a number between 0 (which indicates low-similarity) and 1 (which indicates high-similarity) that gives an indication of similarity for two compared articles. MCVs are computed by using a comparison routine (e.g., a cosine similarity algorithm or other method selected by one skilled in this field to indicate relative similarity of two articles) to compare article content (e.g., article themes, n-grams of article content, etc.) and article metadata (e.g., information represented in table 700, such as issue dates 704, etc.) for pairs of articles. According to aspects of the present invention, 0.5 is considered a threshold of similarity for MCVs. Compared articles with an MCV 408 equal to or above 0.5 are considered similar, and final co-assignment of those articles to a primary-theme-based group 502, 506, 510 is appropriate. According to aspects of the present invention, compared articles with an MCV 410 below 0.5 and above or equal to 0.4 are considered moderately-similar, and an alternate grouping arrangement (seen in FIG. 5 as hashed versions of originally-used circles and squares, respectively) 504, 508 indicating this degree of similarity is appropriate. According to aspects of the present invention, compared articles with an MCV 412 below 0.4 and above or equal to 0.25 are considered marginally-similar, and alternate grouping that indicates this degree of similarity is appropriate.

The server computer 102 determines, via the ACVEM 114 at block 212, whether article regrouping is appropriate. In particular, the MCVEM 114 determines whether any MCVs less than 0.5 exist between article pairs within the established primary-theme-based groups 402, 404, 406. With additional reference to FIG. 4, MCV evaluations for article pairs are now discussed. When compared by MCVEM 114, articles 1 and 2 (respectively shown in nodes 304 and 306) have a relatively-high MCV 408 of 0.75 (represented schematically by a solid line); a similar MCV is calculated between articles 4 and 5 (respectively shown in nodes 310 and 312); a similar MCV is also calculated between articles 7 and 8 (respectively shown in nodes 316 and 318). According to aspects of the invention, initial primary-theme-based groups 402, 404, 406 are sufficient for articles with this relatively-high MCV 408, and no article groups regrouping is necessary. When compared by MCVEM 114, articles 1 and 3 (respectively shown in nodes 304 and 308) have a moderate MCV 410 of 0.45 (represented schematically by a dashed line); a similar MCV is calculated between articles 5 and 6 (respectively shown in nodes 312 and 314). For pairs with this moderate MCV 410, regrouping is appropriate to indicate that, while the compared articles are similar, content is present in one of the compared articles that is not present in the other. When compared by MCVEM 114 articles 7 and 9 (respectively shown in nodes 316 and 320) have a relatively-low MCV 412 of 0.35 (represented schematically by a dotted line). For article pairs with this relatively-low MCV 412, regrouping is appropriate to highlight article differences indicated by notable distinguishing features 708 that differentiate articles in these pairs from one another.

The server computer 102 identifies, via DFIM 116 at block 214, distinguishing features 708 that contributed to MCVs being below the threshold of similarity. In this manner, aspects of the present invention can highlight key attributes of articles 108 that are similar, yet distinct from one another. Examples of similar, yet distinct, article pairs are shown schematically in FIG. 5 (e.g., 304 and 308; 312 and 314; and 316 and 320. Examples of distinguishing features 708 are shown in metadata table 700. For article pairs having MCVs below 0.5, the DFIM identifies the notable distinctions that differentiate members of compared article pairs. For example, as shown in FIG. 7, the distinguishing feature 708 for article 3 is the presence of material related to a previously-discussed criminal event that is not discussed in article 1. Similarly, as also shown in FIG. 7, the distinguishing feature 708 for article 6 is the presence of material related to a previously-discussed criminal event that is not discussed in article 5. Some pairs include more than one distinction. As shown in FIG. 7, two distinguishing features 708 separate article 9 from article 7. First, the issuance dates of article 9 and article 7 are spaced apart by a time gap of more than 3 years; this value indicates a new occurrence of criminal activity. The time gap trigger or same-topic threshold period used to indicate a new event can be adjusted according to the judgment of one skilled in this field. Second, article 9 discusses an event not mentioned in article 7. According to aspects of the invention, this combination of notable distinguishing features 708 likely indicates that content in article 9 that is missing from article 7 describes a new instance of activity of interest (e.g., a new refence topic 108 to be presented for consideration).

The server computer 102, via SGAM 118 in block 216, iteratively reassigns articles with notable distinguishing features 708 into secondary groups 504, 508, 512 that highlight the distinctions between seemingly similar articles in article pairs with CSVs below 0.5. This makes information review less tedious and more efficient, both of which improve accuracy. According to aspects of the present invention, article 3 will be reassigned to new group 504 that is related to group 502, yet distinct. No new criminal activity is indicated when article 3 is re-assigned. According to aspects of the present invention, article 6 will be reassigned to new group 508 that is related to group 506, yet distinct. No new criminal activity is indicated when article 6 is presented. According to aspects of the invention, article 9 will be assigned to new group 512 that represents a distinct event instance to be tracked. Article 9 may also be included a second set of nodes (not shown) that focuses on the instance of the event discussed in article 9.

According to aspects of the invention, the server computer 102 receives at block 218, the articles 108 of set 302 grouped for final distribution as shown in FIG. 7. The server computer 102 displays, stores, or otherwise makes the articles available for efficient consideration during a due diligence investigation or similar activity. In particular, articles 1 and 3 are together in Final Group 1, articles 4 and 5 are together in Final Group 3, and articles 7 and 8 are together in Final Group 5.

It is noted that relatively-high MCVs 408 indicate that compared articles have a common primary theme 706 and are very similar to compared pair-mates. as seen in FIG. 7. Articles in these pairs are almost identical in terms of analysis contribution.

It is noted that moderate MCVs 410 indicate that compared articles have a common primary theme 706 and no notable distinguishing features, as seen in FIG. 7.

It is noted that relatively-low MCVs 412 indicate that although compared articles have a common primary theme 706, notable distinctions 708 are present. According to aspects of the present invention, marginally-similar articles with low MCVs 412 have similar themes and yet differ in meaningful aspects (e.g., may represent two completely separate, yet semantically-similar, occurrences of the same kind of event). According to aspects of the present invention, marginally-similar articles have similar themes and yet differ in meaningful aspects (e.g., may represent two completely separate, yet semantically-similar, occurrences of the same kind of event). Aspects of the present invention ensure that, articles (e.g., article 9) from articles pairs with MCVs 412 in this range are regrouped in a way that can portray important distinctions between semantically-similar articles (e.g., time differences, for example) to help ensure all reference-topic-related articles (including distinct occurrences of similar events) are presented efficiently and properly identified. For article pairs with this MCV 412, regrouping is appropriate to highlight article differences indicated by notable distinguishing features 708 that differentiate the articles in these article pairs from one another.

As shown in FIG. 5 and FIG. 7, articles 1 and 3 are in Final Group 1 (502), article 3 is in Final Group 2 (308); articles 4 and 5 are in Final Group 3 (506); articles 7 and 8 are in Final Group 5 (510); and article 9 is in Final Group 6 (512).

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

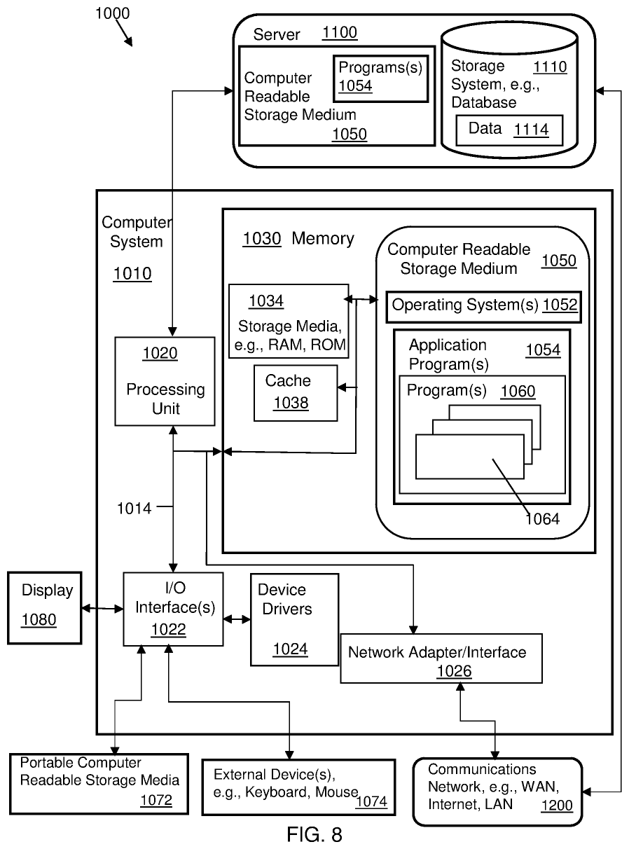

Referring to FIG. 8, a system or computer environment 1000 includes a computer diagram 1010 shown in the form of a generic computing device. The method 100, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that the control system 70 (shown in FIG. 8) can include all or part of the computer system 1010 and its components, and/or the control system can communicate with all or part of the computer system 1010 and its components as a remote computer system, to achieve the control system functions described in the present disclosure. It is also understood that the one or more communication devices 110 shown in FIG. 1 similarly can include all or part of the computer system 1010 and its components, and/or the communication devices can communicate with all or part of the computer system 1010 and its components as a remote computer system, to achieve the computer functions described in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text articles (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

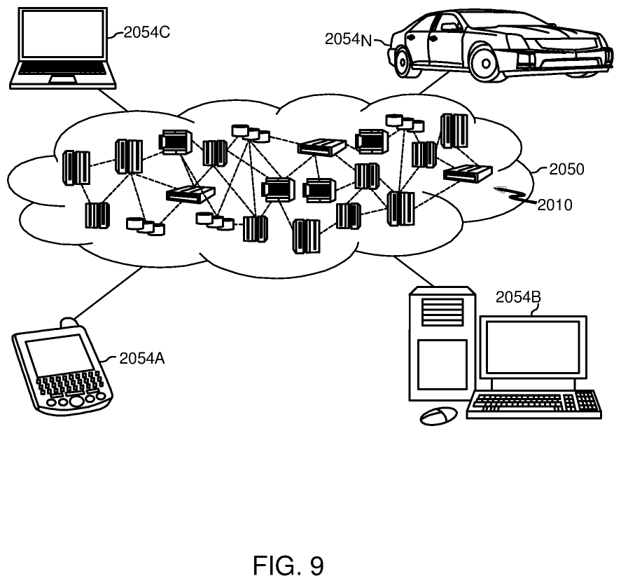

Referring now to FIG. 9, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 9 are intended to be illustrative only and that computing nodes 2010 and cloud computing environment 2050 can communicate with any type of computerized device over any type of network and/or network addressable connection (e.g., using a web browser).

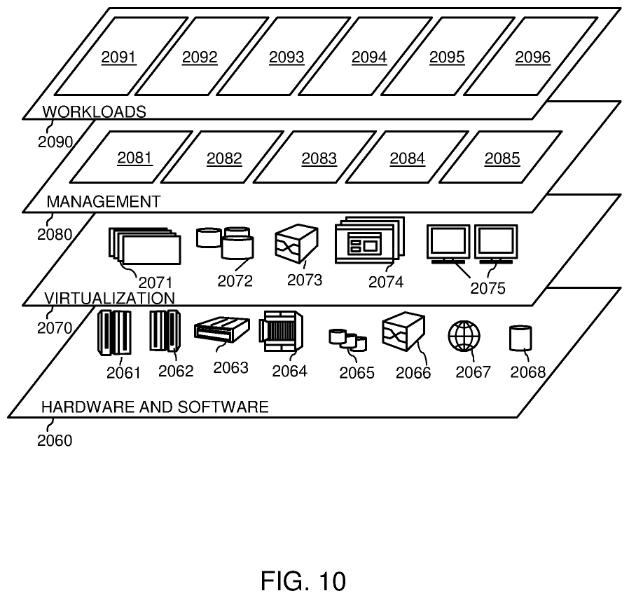

Referring now to FIG. 10, a set of functional abstraction layers provided by cloud computing environment 2050 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and grouping articles having related content and distinguishing between similar articles 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method to selectively group topical content comprising:
receiving, by said computer, a list of reference topics from a topic database;
receiving, by said computer, a set of articles related to said reference topics;
generating for each article, by said computer, an article n-gram that represents the content of the associated article;
comparing, by said computer, using Natural Language Processing (NLP), said article n-grams with said reference topics to determine which of said reference topics is most similar to each of said article n-grams;
responsive to said comparing, by said computer, assigning a primary theme to the articles associated with each of said compared article n-grams, said assigned primary themes each corresponding respectively to the most-similar reference topic;
collecting, by said computer, articles with common primary themes into at least one article group and determining, by said computer, an article comparison value between articles in the at least one article group;
responsive to determining, by said computer, an article comparison value that is below a predetermined similarity threshold, determining, by said computer, at least one distinguishing feature associated with at least one of the compared articles that contributed to the article comparison value; and
assigning, by said computer, articles having said distinguishing feature into a secondary group based, at least in part, on said at least one distinguishing feature.

2. The method of claim 1, wherein, said reference topics are selected from a list consisting of activities and related phases thereof.

3. The method of claim 1, wherein, said primary themes are determined, at least in part, by receiving, by said computer, sets of topic n-grams representing said reference topics; generating, by said computer, sets of article n-grams representing content of said articles; and comparing, by said computer, said article n-grams with said topic n-grams.

4. The method of 1, wherein said article comparison value is determined, at least in part, by generating, by said computer, article feature vectors representing content of articles and comparing, by said computer, article feature vectors of pairs of articles in said at least one group.

5. The method of 4, wherein said feature vectors are compared, by said computer, by a cosine similarity algorithm.

6. The method of 1, wherein said at least one distinguishing feature is selected, by said computer, from a list consisting of a relevant date, and presence of a secondary theme.

7. The method of 6, wherein said at least one distinguishing feature includes an article date for a first compared article that is separated time-wise from an article date for a second compared article by a time gap larger than a predetermined same-topic threshold.

8. A system to selectively group topical content, which comprises:
a computer system comprising a computer readable storage medium having program instructions embodied therewith, the program instructions executable by a computer to cause the computer to:
receive a list of reference topics from a topic database;
receive a set of articles related to said reference topics;
generate, for each article, an article n-gram that represents the content of the associated article;
compare, using Natural Language Processing (NLP), said article n-grams with said reference topics to determine which of said reference topics is most similar to each of said article n-grams;
responsive to said comparing, assign a primary theme to the articles associated with each of said compared article n-grams, said assigned primary themes each corresponding respectively to the most-similar reference topic;
collect articles with common primary themes into at least one article group and determine an article comparison value between articles in the at least one article group;
responsive to determining an article comparison value that is below a predetermined similarity threshold, determine at least one distinguishing feature associated with at least one of the compared articles that contributed to the article comparison value; and
assign articles having said distinguishing feature into a secondary group based, at least in part, on said at least one distinguishing feature.

9. The system of claim 8, wherein, said reference topics are selected from a list consisting of activities and related phases thereof.

10. The system of claim 8, wherein, said primary themes are determined, at least in part, by causing said computer to receive sets of topic n-grams representing said reference topics; causing said computer to generate sets of article n-grams representing content of said articles; and
causing said computer to compare said article n-grams with said topic n-grams.

11. The system of 8, wherein said article comparison value is determined, at least in part, by causing said computer to generate article feature vectors representing content of articles and causing said computer to compare article feature vectors of pairs of articles in said at least one group.

12. The system of 11, further including instructions causing the computer to compare feature vectors are compared by a cosine similarity algorithm.

13. The system of 8, further including instructions causing said computer to select said distinguishing feature from a list consisting of a relevant date, and presence of a secondary theme.

14. The system of 13, wherein said at least one distinguishing feature includes an article date for a first compared article that is separated time-wise from an article date for a second compared article by a time gap larger than a predetermined same-topic threshold.

15. A computer program product to selectively group topical content, the computer program product comprising a computer readable storage medium having program instructions embodied therewith, the program instructions executable by a computer to cause the computer to:
receive, using said computer, a list of reference topics from a topic database;
receive, using said computer, a set of articles related to said reference topics;
generate, for each article, using said computer, an article n-gram that represents the content of the associated article;
compare, using said computer, using Natural Language Processing (NLP), said article n-grams with said reference topics to determine which of said reference topics is most similar to each of said article n-grams;
responsive to said comparing, assign, using said computer, a primary theme to the articles associated with each of said compared article n-grams, said assigned primary themes each corresponding respectively to the most-similar reference topic;
collect, using said computer, articles with common primary themes into at least one article group and determine an article comparison value between articles in the at least one article group;
responsive to determining an article comparison value that is below a predetermined similarity threshold, determine, using said computer, at least one distinguishing feature associated with at least one of the compared articles that contributed to the article comparison value; and
assign, using said computer, articles having said distinguishing feature into a secondary group based, at least in part, on said at least one distinguishing feature.

16. The computer program product of claim 15, wherein, said reference topics are selected from a list consisting of activities and related phases thereof.

17. The computer program product of claim 15, wherein, said primary themes are determined, at least in part, by using said computer to receive sets of topic n-grams representing said reference topics; generating, using said computer, sets of article n-grams representing content of said articles; and comparing, using said computer, said article n-grams with said topic n-grams.

18. The computer program product of 15, wherein said article comparison value is determined, at least in part, by generating, using said computer, article feature vectors representing content of articles and comparing, using said computer, article feature vectors of pairs of articles in said at least one group.

19. The computer program product of 15, further including instructions causing said computer to select, using said computer, said distinguishing feature from a list consisting of a relevant date, and presence of a secondary theme.

20. The computer program product of 19, wherein said at least one distinguishing feature includes an article date for a first compared article that is separated time-wise from an article date for a second compared article by a time gap larger than a predetermined same-topic threshold.
